(19) United States
(12) Patent Application Publication
(10) Pub. No.: US 2022/0080452 A1
(43) Pub. Date: Mar. 17, 2022

(54) LIQUID METAL APPLYING METHOD

(71) Applicant: Morningrich Technology Co., Ltd., Kaohsiung City (TW)

(72) Inventors: Li-Chen HSIEH, Kaohsiung City (TW); Chiu-Lang LIN, Kaohsiung City (TW)

(21) Appl. No.: 17/018,405

(22) Filed: Sep. 11, 2020

(51) Int. Cl. B05C 5/02; B05C 5/00; B05C 9/14; B05C 11/02

(52) U.S. Cl. CPC B05C 5/0291; B05C 11/028; B05C 9/14; B05C 5/001

(57) ABSTRACT

Disclosed herein is a method for applying a liquid metal on a surface of an object that is selected from the group consisting of a heat-emitting surface and a heat-conducting surface. The method includes applying the liquid metal onto the surface, and applying a force to the liquid metal using a tool to destroy cohesion of the liquid metal, followed by moving the tool back and forth to apply the liquid metal on the surface.

### FIELD

The disclosure relates to a method for applying a liquid metal on a surface of an object that is selected from a heat-emitting surface and a heat-conducting surface.

### BACKGROUND

Liquid metals (metals in liquid form at the operating temperature of an electronic component), such as alloys of gallium, indium, and tin, potentially offer both low interfacial resistance and high electrical conductivity. Several alloys of gallium with very low melting points have also been identified as potential liquid metal interface materials. Alloy systems that are liquids at room temperature have thermal conductivity far superior to that of ordinary non-metallic liquids, allowing liquid metals to efficiently transfer energy from a heat source. This characteristic renders these materials suitable for specific heat conducting and/or dissipation applications.

The surface tensions of liquid metals containing gallium, indium, and tin are 718 mN/m, 556 mN/m, and 865 mN/m, respectively, and the surface tension of water is 72.75 mN/m, which means that the liquid metal has significantly higher cohesion. Therefore, when the liquid metal is applied to the surface of a central processing unit (CPU), a graphics processing unit (GPU), or a heat sink, the liquid metal will have a spherical shape due to its high cohesion, resulting in its inability to completely adhere to the surface of the CPU, GPU, or heat sink, and thereby reducing the thermal conductivity. In addition, in the automated manufacturing process of the CPU, GPU, or heat sink, the liquid metal must be uniformly coated on the heat-emitting surface of a designated object in a very short time (for example, about 10 seconds) to meet the needs of the industry.

### SUMMARY

Accordingly, in a first aspect, the present disclosure provides a method for applying a liquid metal on a surface of an object that is selected from the group consisting of a heat-emitting surface and a heat-conducting surface. The method includes:
a) extruding the liquid metal from a syringe onto the surface; and
b) applying a force to the liquid metal using a tool to destroy cohesion of the liquid metal, followed by moving the tool back and forth to apply the liquid metal on the surface.

In a second aspect, the present disclosure provides another method for applying a liquid metal on a surface of an object that is selected from the group consisting of a heat-emitting surface and a heat-conducting surface. The method includes:
a) dipping a tool into the liquid metal, followed by applying the liquid metal onto the surface; and
b) applying a force to the liquid metal using the tool to destroy cohesion of the liquid metal, followed by moving the tool back and forth to apply the liquid metal on the surface.

### BRIEF DESCRIPTION OF THE DRAWINGS

Other features and advantages of the disclosure will become apparent in the following detailed description of the embodiments with reference to the accompanying drawings, of which:

FIGS. 1 to 4 are schematic views illustrating a first embodiment of a method for applying a liquid metal on a heat-emitting surface of an object according to the present disclosure;

FIGS. 5 to 8 are schematic views illustrating variations of the first embodiment;

FIG. 9 is a schematic view illustrating a second embodiment of the liquid metal applying method according to the present disclosure; and

FIG. 10 is a schematic view illustrating a variation of the second embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

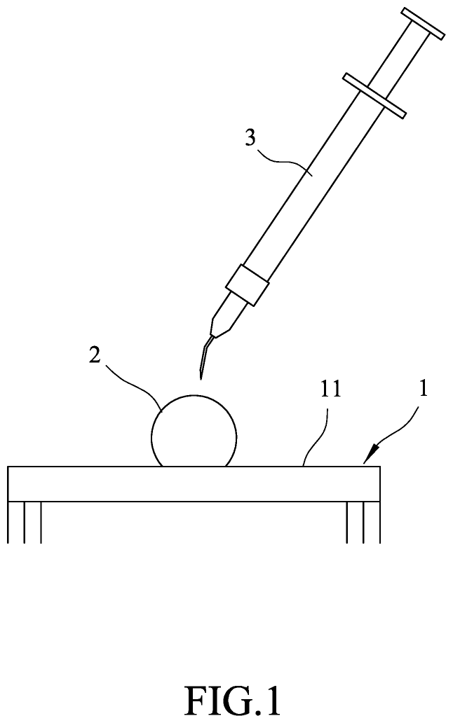

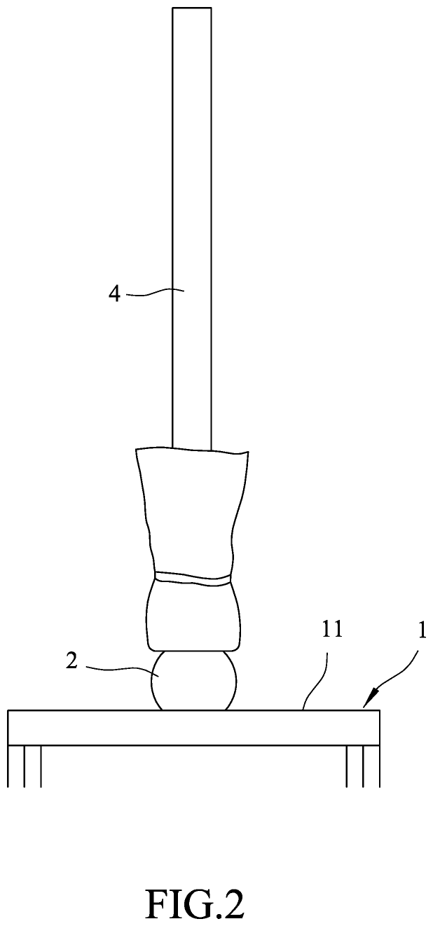

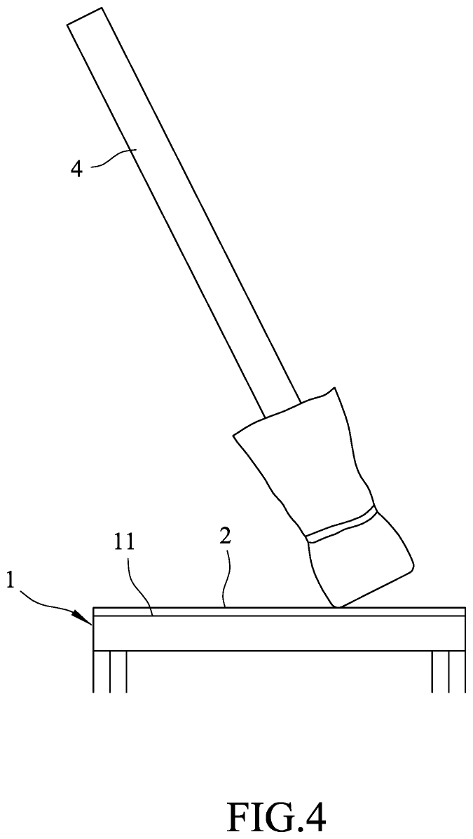

Referring to FIGS. 1 to 4, a first embodiment of a liquid metal applying method according to the present disclosure is for applying a liquid metal 2 on a heat-emitting surface 11 of an object 1, and includes:
a) extruding the liquid metal 2 from a syringe 3 onto the heat-emitting surface 11; and
b) applying a force to the liquid metal 2 using a tool 4 to destroy cohesion of the liquid metal 2, followed by moving the tool 4 back and forth to apply the liquid metal 2 on the heat-emitting surface 11.

Examples of the object 1 include, but are not limited to, a central processing unit (CPU), a graphics processing unit (GPU), and a heat sink.

In step (a) of this embodiment, the liquid metal 2 is present in a spherical or hemispherical form on the heat-emitting surface 11. The liquid metal 2 may be extruded in a single time, or may be extruded in several times, so that the liquid metal 2 is dispersedly or adjacently distributed on the heat-emitting surface 11.

In this embodiment, the liquid metal 2 is an alloy of gallium, indium, and tin (Galinstan).

In step (b) of this embodiment, the tool 4 is used to apply a downward force to the liquid metal 2 in a surface contact manner to destroy the cohesion of the liquid metal 2, followed by the back-and-forth movement of the tool 4 for uniformly applying the liquid metal 2 on the heat-emitting surface 11.

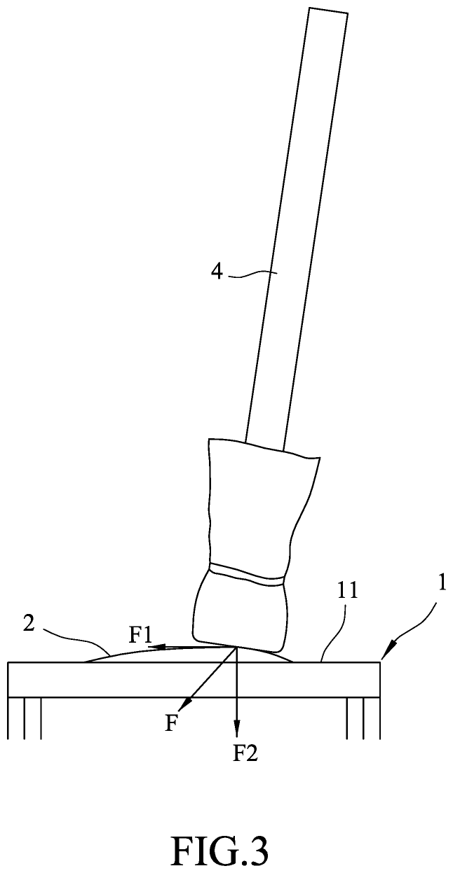

In step (b) of this embodiment, the tool 4 may also be used to apply a force F obliquely to the liquid metal 2 to generate a horizontal force component F1 and a vertical force component F2 (see FIG. 3), thereby ensuring full destruction of the cohesion of the liquid metal 2.

The tool 4 may be operated manually or driven by an automated machine, and an automated robot dispenser may be used as the syringe 3 in step (a) (see FIG. 1), so that the liquid metal 2 can be applied on the heat-emitting surface 11 in a large amount and quickly, thereby improving the efficiency of the production line.

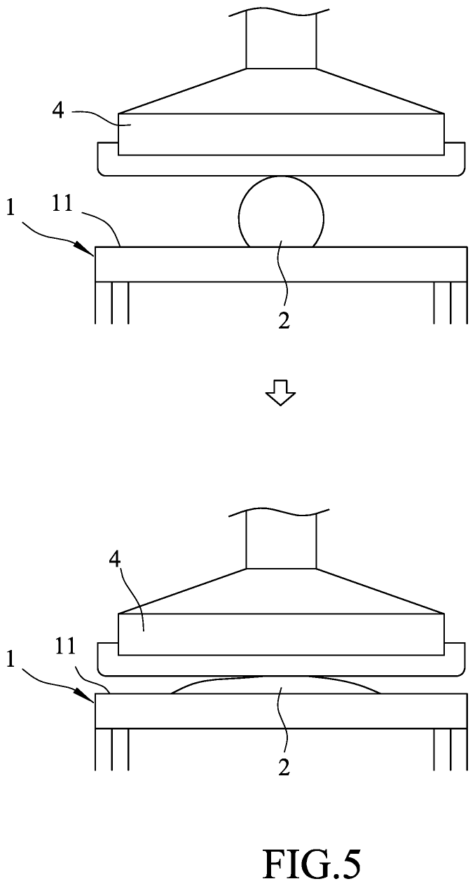

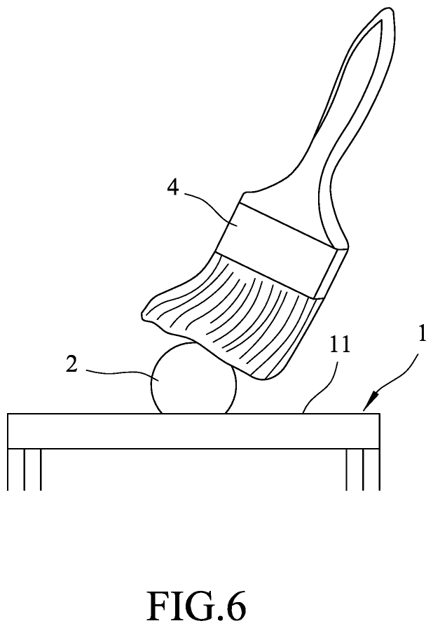

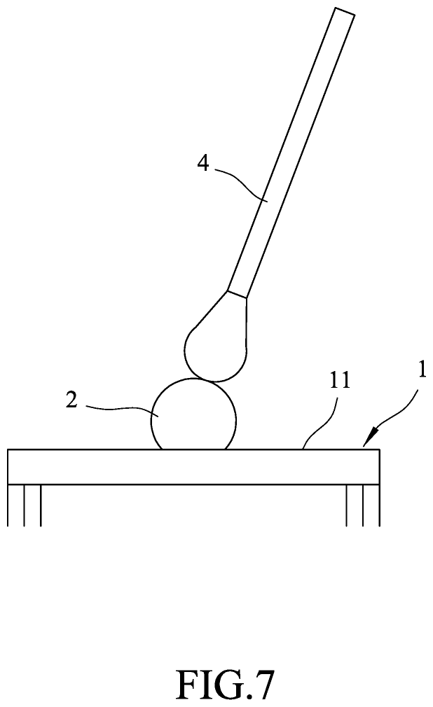

Examples of the tool 4 include, but are not limited to, a spreading rod (see FIGS. 1 to 4), a spatula (see FIG. 5), a brush (see FIG. 6), and a cotton swab (see FIG. 7) (i.e. these are variations of the first embodiment).

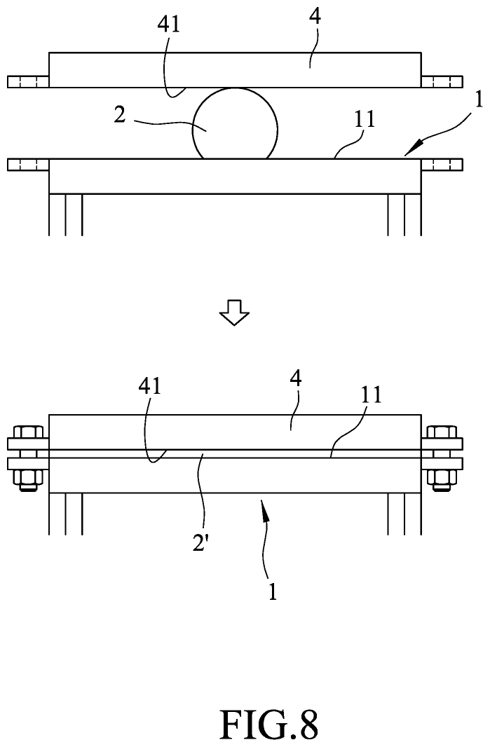

Referring to FIG. 8, in step (b) of another variation of this embodiment, the tool 4 may be an element which is detachably disposed on the object 1 (such as a thermal module disposed on a CPU), and has a heat-conducting surface 41 facing the heat-emitting surface 11. The tool 4 is operated to apply a downward force to the liquid metal 2, so that the heat-conducting surface 41 is pressed against the surface of the liquid metal 2 to destroy the cohesion of the liquid metal 2, and a liquid metal layer 2′ is formed between the heat-emitting surface 11 and the heat-conducting surface 41. The tool 4 may be detachably disposed on the object 1 using a lock screw, and is not limited thereto.

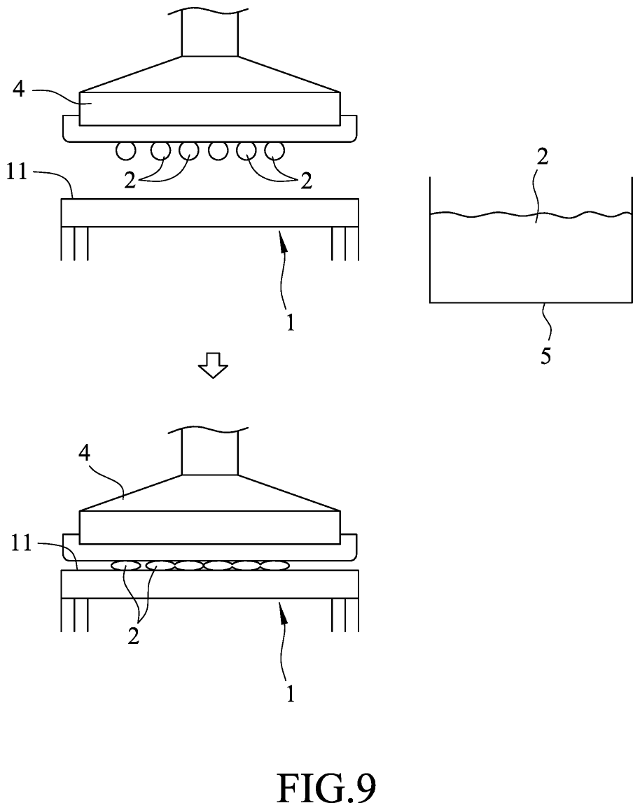

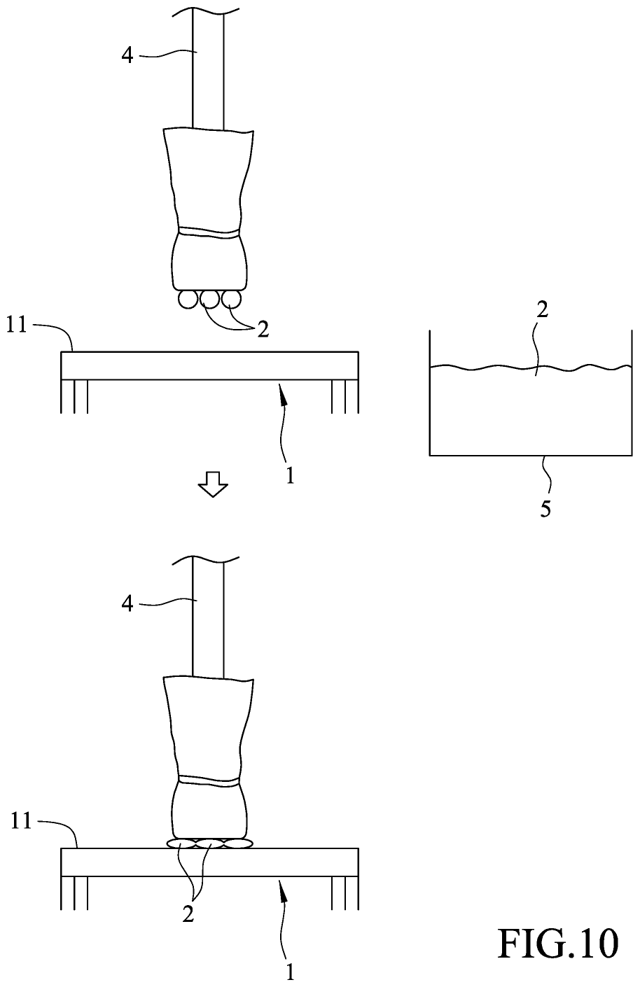

Referring to FIGS. 9 to 10, a second embodiment of the liquid metal applying method according to the present disclosure includes:
a) dipping a tool 4 into a liquid metal 2 stored in a container 5, followed by applying the liquid metal 2 onto a heat-emitting surface 11 of an object 1; and
b) applying a force to the liquid metal 2 using the tool 4 to destroy cohesion of the liquid metal 2, followed by moving the tool 4 back and forth to apply the liquid metal 2 on the heat-emitting surface 11.

Examples of the tool 4 include, but are not limited to, a spreading rod (see FIG. 10), a spatula (see FIG. 9), a brush, and a cotton swab.

In the second embodiment, the tool 4 may be an element as described above, which is detachably disposed on the object 1 and has a heat-conducting surface 41 (see FIG. 8) facing the heat-emitting surface 11. The heat-conducting surface 41 may be used to dip into the liquid metal 2.

In conclusion, the method according to the present disclosure can achieve satisfactory liquid metal applying by the following steps: applying the liquid metal 2 onto the heat-emitting surface 11 using the syringe 3 or bring the liquid metal 2 onto the heat-conducting surface 41 by direct dipping, applying a downward force to the liquid metal 2 in a surface contact manner to destroy the cohesion of the liquid metal 2, and moving the tool 4 back and forth to apply the liquid metal 2 on the heat-emitting surface 11. The steps of the method according to the present disclosure are simple and time-efficient, and thus can be applied to automated machines to facilitate automated mass production, thereby improving the efficiency of the production line.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for applying a liquid metal on a surface of an object, the surface being selected from the group consisting of a heat-emitting surface and a heat-conducting surface, the method comprising:
a) extruding the liquid metal from a syringe onto the surface; and
b) applying a force to the liquid metal using a tool to destroy cohesion of the liquid metal, followed by moving the tool back and forth to apply the liquid metal on the surface.

2. The method according to claim 1, wherein in step (b), the tool is selected from the group consisting of a spreading rod, a spatula, a brush, and a cotton swab.

3. The method according to claim 1, wherein in step (b), the force is applied to the liquid metal from thereabove and in a surface contact manner to destroy the cohesion of the liquid metal.

4. The method according to claim 1, wherein the surface of the object is the heat-emitting surface, and in step (b), the tool, which is detachably disposed on the object and has a heat-conducting surface facing the surface of the object, is used to apply the force to the liquid metal from thereabove, so that the heat-conducting surface is pressed against a surface of the liquid metal to destroy the cohesion of the liquid metal, and so that a liquid metal layer is formed between the heat-emitting surface and the heat-conducting surface.

5. A method for applying a liquid metal on a surface of an object, the surface being selected from the group consisting of a heat-emitting surface and a heat-conducting surface, the method comprising:
a) dipping a tool into the liquid metal, followed by applying the liquid metal onto the surface; and
b) applying a force to the liquid metal using the tool to destroy cohesion of the liquid metal, followed by moving the tool back and forth to apply the liquid metal on the surface.

6. The method according to claim 5, wherein in step (a), the tool is selected from the group consisting of a spreading rod, a spatula, a brush, and a cotton swab.

7. The method according to claim 5, wherein in step (b), the force is applied to the liquid metal from thereabove and in a surface contact manner to destroy the cohesion of the liquid metal.

8. The method according to claim 5, wherein the surface of the object is the heat-emitting surface, and the tool, which is detachably disposed on the object and has a heat-conducting surface facing the surface of the object, is used to apply the force to the liquid metal from thereabove, so that the heat-conducting surface is pressed against a surface of the liquid metal to destroy the cohesion of the liquid metal, and so that a liquid metal layer is formed between the heat-emitting surface and the heat-conducting surface.
